(19) United States
(12) Patent Application Publication
(10) Pub. No.: US 2008/0029992 A1
(43) Pub. Date: Feb. 7, 2008

(54) Multi-Speed Fixed-Drive Push Rim Wheelchair

(76) Inventors: Stuart M. Lindsay, Burlington, VT (US); David Winters McMath, Hinesburg, VT (US); Mark P. Walker, Jericho, VT (US)

Correspondence Address: FISH & RICHARDSON PC, P.O. BOX 1022, MINNEAPOLIS, MN, 55440-1022, US

(21) Appl. No.: 11/461,899

(22) Filed: Aug. 2, 2006

(51) Int. Cl. B62M 1/14

(52) U.S. Cl. 280/250.1

(57) ABSTRACT

Multi-speed fixed gear hub transmissions are provided for push rim wheelchairs. Push rim wheelchairs having such transmissions are also provided. The hub transmission generally includes a hub driver, a hub and a drive train, configured to transmit rotational force from the hub driver to the hub. In some implementations, the drive train transmits torque at each of at least three gear ratios, and defines at least three different torque transmission paths between the hub driver and the hub, each path defining a respective one of the gear ratios, and each of the transmission paths including only rigid bodies, each of the rigid bodies being configured to transmit torque in both forward and reverse rotational directions. In other implementations, the drive train transmits rotational force at each of at least two gear ratios.

### TECHNICAL FIELD

This invention relates to multi-speed push rim wheelchairs, and to hub transmissions for such wheelchairs.

### BACKGROUND

Numerous attempts have been made to produce a manual wheelchair drive system propelled by a push rim that includes fixed-drive, multiple-gear propulsion to enable the operator greater mechanical advantage. This includes a driven-wheel-to-push-rim ratio of less than one-to-one for hill climbing and includes a driven-wheel-to-push-rim-ratio of greater than one-to-one for increased travel of the driven wheel per revolution of the push rim.

The basic criteria for an advanced push rim drive system include: a direct drive with a gear ratio of less than one-to-one, a gear ratio of one-to-one, a gear ratio greater than one-to-one, and a series of interfaces between the push rim and the driven wheel that result in an immediate transmission of rotational force from the push rim to the driven wheel. Immediate transmission of rotational force is defined as not more than one degree of push rim rotation prior to driven wheel rotation.

A push rim wheelchair drive system is desired that meets all of the above criteria.

### SUMMARY

This invention relates to mobility assistance devices and more particularly to a hand propelled drive system of a push rim wheelchair that includes a multiple-gear, fixed-drive hub transmission.

In several aspects, the invention features push rim wheelchairs that include (a) a wheel assembly including a drive wheel, (b) a push rim positioned for manual operation by a user of the wheelchair, and (c) a multi-speed hub transmission configured to transmit torque from the push rim to the drive wheel.

In a first such aspect, the multi-speed hub transmission comprises (a) a hub connected to the drive wheel of the wheelchair, (b) a hub driver connected to the push rim of the wheelchair, (c) a drive train, configured to transmit torque from the hub driver to the hub at each of at least three gear ratios, the drive train comprising cooperating gears and defining at least three different torque transmission paths between the hub driver and the hub, each path defining a respective one of the gear ratios, and (d) a gear selector manipulable to select between the multiple gear ratios by selectively engaging respective torque transmission paths of the drive train. Each of the transmission paths includes only rigid bodies, with each of the rigid bodies being configured to transmit torque in both forward and reverse rotational directions.

In a second aspect, the multi-speed hub transmission comprises (a) a hub, connected to the drive wheel, (b) a hub driver, connected to the push rim, and (c) a drive train, positioned within the hub and configured to transmit torque between the hub driver and the hub at each of at least three gear ratios. In this aspect, the drive train exhibits a backlash of less than 5 degrees when a force is first transmitted to the push rim by an operator of the wheelchair. Backlash is measured as the rotational displacement of the push rim relative to the drive wheel assembly.

In a third aspect, the multi-speed hub transmission comprises (a) a hub, connected to the drive wheel, (b) a hub driver, connected to the push rim, (c) a gear selector, positioned to allow an operator of the wheelchair to select between speeds of the transmission, and (d) a drive train, comprising cooperating gears configured to transmit torque between the hub driver and the hub at each of at least two gear ratios including a first gear ratio greater than one-to-one, and a second gear ratio less than or equal to one-to-one. In this aspect, the torque of the drive train is transmitted to the hub through a drive plate for the second gear ratio, and through a ring gear integral to the hub for the first gear ratio.

Some implementations include one or more of the following features. In the first and second aspects discussed above, the torque of the drive train may be transmitted to the hub through a drive plate at gear ratios equal to or less than one-to-one, and through a ring gear integral to the hub in the case of a gear ratio greater than one-to-one.

Each set of gears may include a first gear member having a geometric recess configured to be engaged by a corresponding cooperating geometric member to selectively engage the set of gears, in which case one of the corresponding geometric members may be a coupler that is configured to move axially within the hub and another of the corresponding geometric members may be mounted on a second gear member of one of the sets of gears and configured to engage the geometric recess in the first gear of an adjacent set of gears. The wheelchair multi-speed hub transmission may further include a member constructed to apply a lateral force to the coupler in a first direction, and a resilient element constructed to apply a lateral force to the coupler in a second, opposite direction. The gear selector may be configured to adjust the lateral force in the first direction when the gear selector is moved between predetermined positions.

In some cases, at least two of the sets of gears include, as one of the cooperating gears, a planetary gear assembly. For example, each of the three transmission paths may include a planetary gear assembly. In some implementations, in one of the transmission paths the planetary gear assembly is driven directly by the coupler, and in another of the transmission paths the planetary gear assembly is driven by a reduction gear, which is in turn driven by the coupler.

In certain implementations, the hub defines a portion of one of the sets of gears, and may further define a recess configured to be engaged by a correspondingly shaped outer portion of another of the sets of gears.

The gear selector may be positioned at an end of the hub assembly, or, alternatively, on a frame of the wheelchair.

The drive train is preferably configured to provide a fixed gear transmission of torque, and to provide less than 5 degrees of backlash, preferably less than 1 degree of backlash or substantially no backlash, when force is first applied by the user to the push rim.

It is noted that these features can be included in any desired combination.

For example, in some implementations the wheelchair includes all of the following features: the multi-speed hub transmission comprises (a) a hub connected to the drive wheel of the wheelchair, (b) a hub driver connected to the push rim of the wheelchair, (c) a drive train, configured to transmit torque from the hub driver to the hub at each of at least three gear ratios, the drive train comprising cooperating gears and defining at least three different torque transmission paths between the hub driver and the hub, each path defining a respective one of the gear ratios, and (d) a gear selector manipulable to select between the multiple gear ratios by selectively engaging respective torque transmission paths of the drive train. Each of the transmission paths includes only rigid bodies. Each of the rigid bodies is configured to transmit torque in both forward and reverse rotational directions. The torque of the drive train is transmitted to the hub through a drive plate at gear ratios equal to or less than one-to-one, and the through a ring gear integral to the hub in the case of a gear ratio greater than one-to-one. Each set of gears includes a first gear member having a geometric recess configured to be engaged by a corresponding cooperating geometric member to selectively engage the set of gears, one of the corresponding geometric members comprises a coupler that is configured to move axially within the hub and another of the corresponding geometric members is mounted on a second gear member of one of the sets of gears and configured to engage the geometric recess in the first gear of an adjacent set of gears. The wheelchair multi-speed hub transmission further includes a member constructed to apply a lateral force to the coupler in a first direction, and a resilient element constructed to apply a lateral force to the coupler in a second, opposite direction.

In other aspects, the invention features methods of using the wheelchairs discussed herein, for example by grasping the push rim and applying torque thereto, and using the gear selector to shift between different gear ratios.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a multiple gear push rim wheelchair drive system including a push rim (manual) wheelchair and, attached to the wheelchair, a pair of hub transmissions, each of which has a manual gear selector positioned a the unsupported end of the hub axle.

FIG. 2 is a perspective view of a multiple gear push rim wheelchair drive system similar to that shown in FIG. 1, in which a remote manual gear selector is positioned on the frame of the wheelchair.

FIG. 3 is a perspective exploded view of a three gear push rim hub assembly with a manual gear selector positioned at the unsupported end of the hub axle.

FIG. 4 is a detailed axial cross sectional view of the three gear hub assembly of FIG. 3. In FIG. 4, the components of the hub assembly are positioned to provide a one-to-one gear ratio.

FIG. 5 shows the hub assembly of FIG. 4 with the components positioned to provide a less than one-to-one gear ratio

FIG. 6 shows the hub assembly of FIG. 4 with the components positioned to provide a more than one-to-one gear ratio.

FIG. 7 is a detailed axial cross sectional view of a three gear hub assembly having a gear shift rod positioned at the supported axle end, with the components positioned to provide a one-to-one gear ratio.

FIG. 8 is a perspective exploded view of a two gear push rim hub assembly with a manual gear selector positioned at the unsupported end of the hub axle.

FIG. 9 is a detailed axial cross sectional view of the hub assembly of FIG. 8, positioned in a one-to-one gear ratio.

FIG. 10 shows the hub assembly of FIG. 9 positioned in a less than one-to-one gear ratio

FIG. 11 shows the hub assembly of FIG. 9 positioned in a one-to-one gear ratio.

FIG. 12 is a detailed cross sectional top view of a manual gear selector positioned at the unsupported end of a hub axle.

FIG. 13 is a detailed cross sectional top view of another embodiment of a three gear hub assembly, incorporating first and second planetary gear cages affixed to a hex drive plate.

Like reference symbols in the various drawings generally indicate like elements.

### DETAILED DESCRIPTION

### Wheelchair Systems

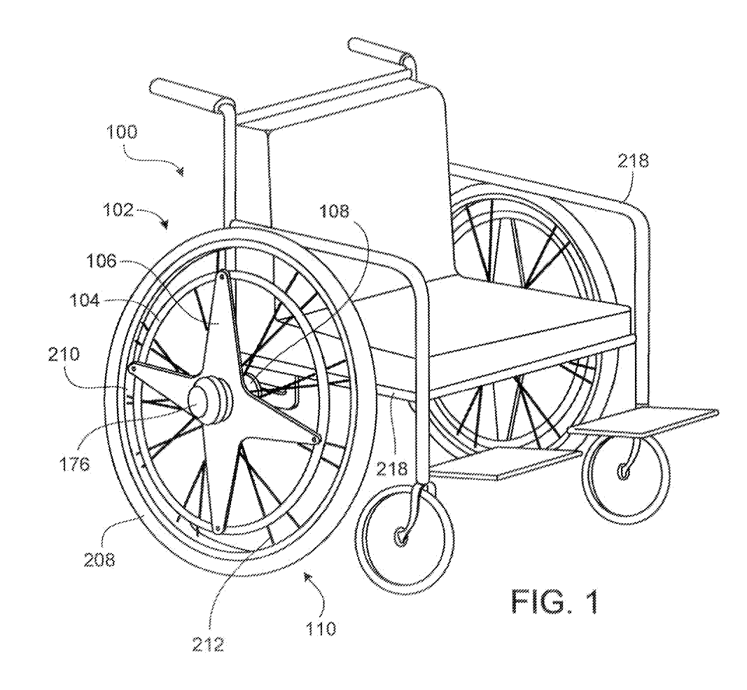

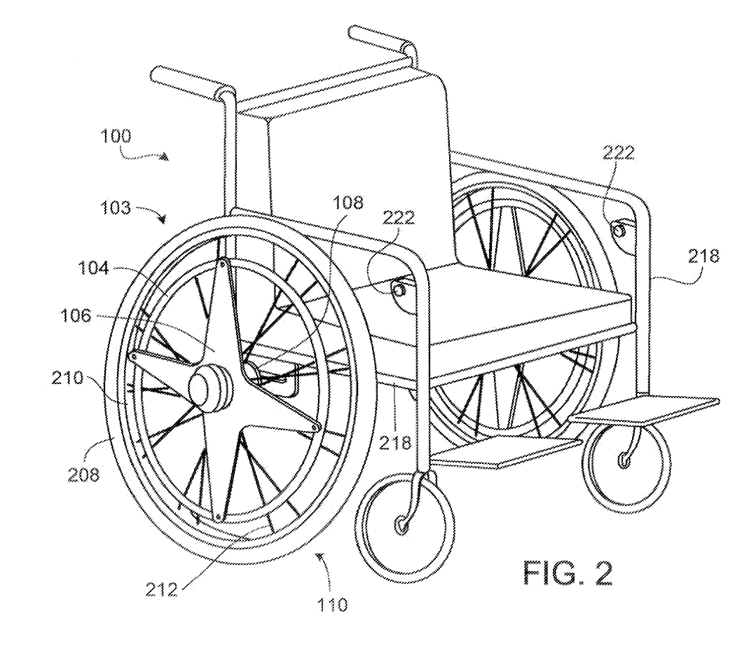

Referring to FIGS. 1 and 2, a multiple gear push rim wheelchair propulsion system 102, 103 includes a wheelchair 100, a push rim 104, a push rim drive plate 106, a hub assembly 108 (FIG. 1) or 109 (FIG. 2) and a driven wheel assembly 110. (It is noted that the hub assembly may, alternatively, be one of the hub assemblies 248 and 249 discussed in detail below.) The driven wheel assembly 110 includes a tire 208, a rim 210 and spokes 212. The push rim 104 is attached to the push rim drive plate 106, which is in turn attached to the hub assembly 108 or 109. Each hub assembly 108, 109, 248, 249 includes an internal transmission that allows the wheelchair system to be shifted by the user between various gears, for example between three speeds (e.g., less than 1.1 gear ratio, 1:1 gear ratio and greater than 1:1 gear ratio) or between two speeds (e.g., 1:1 gear ratio and less than 1:1 gear ratio). Rotation of the push rim 104 in a forward or rearward direction results in a corresponding rotation of the driven wheel assembly 110 in a forward or rearward direction, respectively.

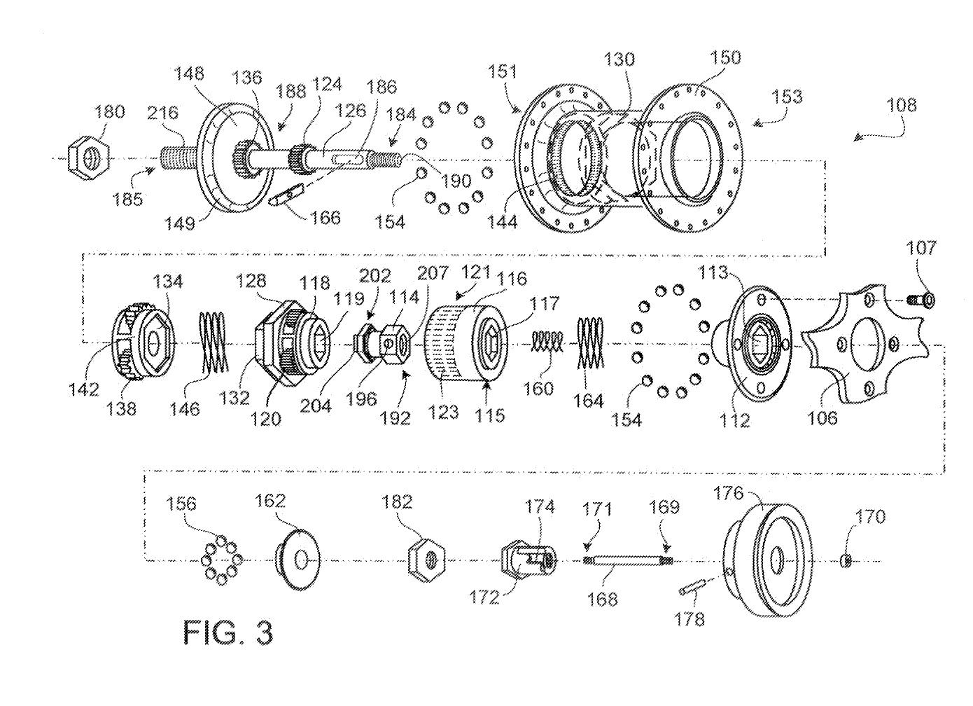

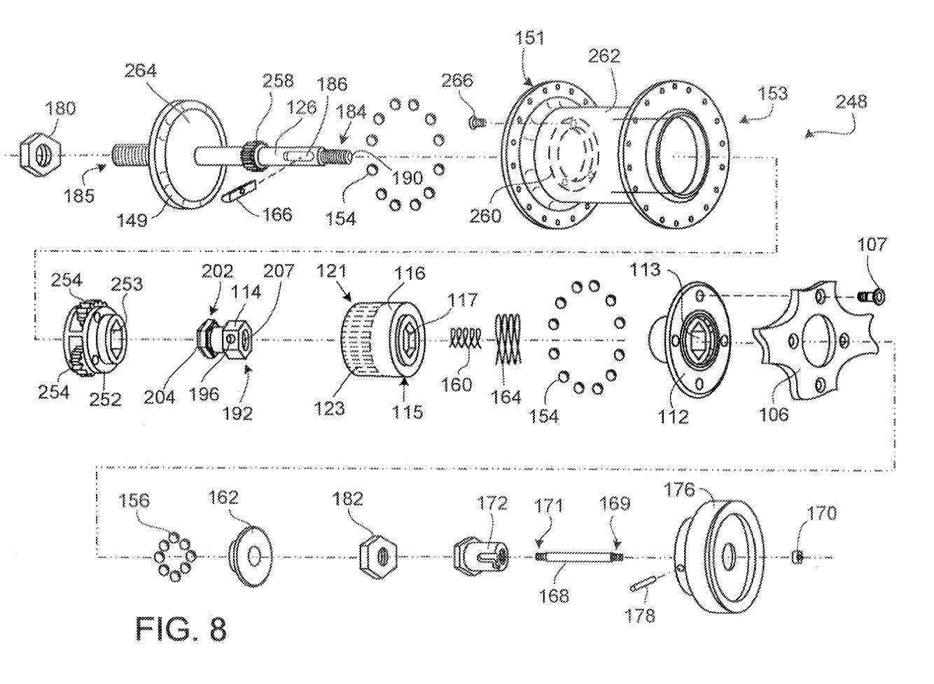

In one implementation, shown in FIG. 1, the wheelchair propulsion system 102 includes a gear selector knob 176 that is positioned on the outer end of the three speed hub assembly 108 (FIG. 3) or the two speed hub assembly 248 (FIG. 8). The user turns this knob between three positions (for a three-speed hub assembly 108) or two positions (for a two speed hub assembly 248) to select the desired gear ratio.

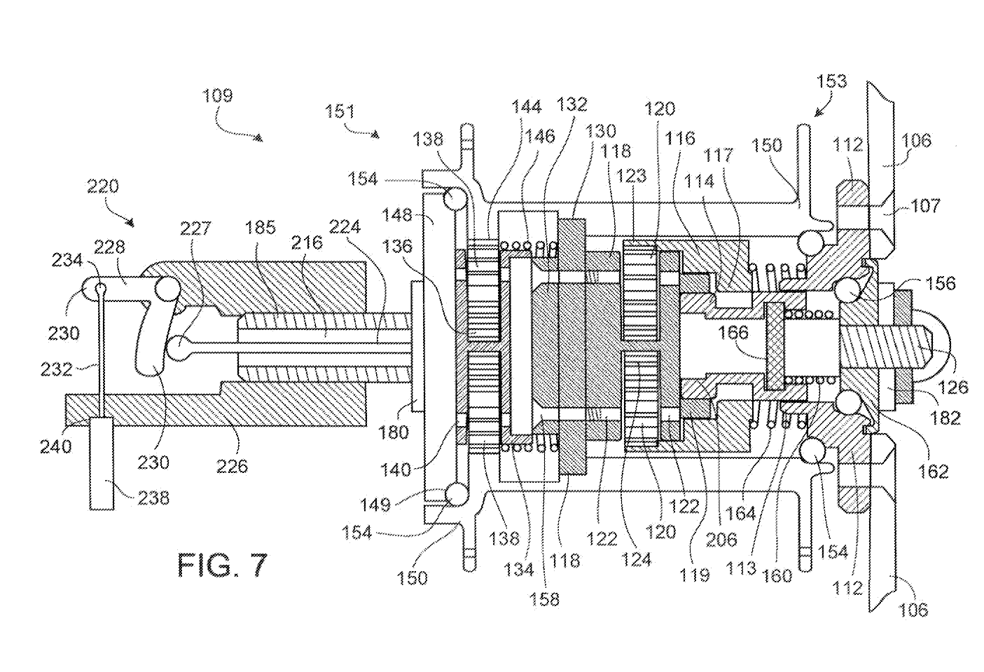

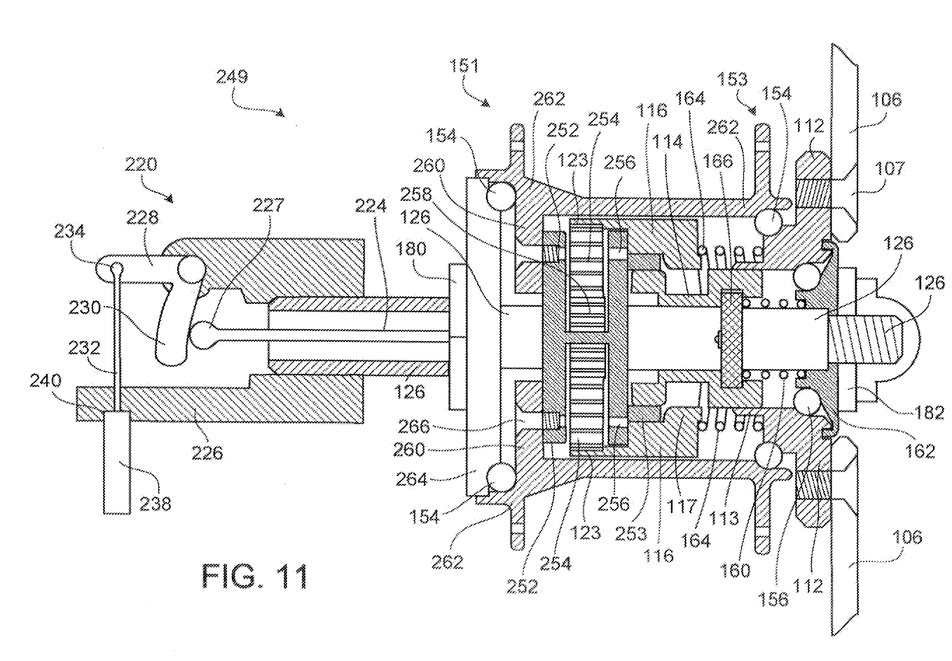

In another implementation, shown in FIG. 2, a wheelchair propulsion system 103 includes a gear selector 222 that is located on the wheelchair frame 218 in a position convenient to the user. The gear selector 222 is connected by a cable 232 (FIGS. 7 and 11) to a bell crank 228 to allow the user's inputs to be transmitted from the gear selector to either the three speed hub assembly 108 or the two speed hub assembly 248.

The different types of hub assemblies (three speed, two speed, gear selector at hub assembly, gear selector on frame) will now be discussed in detail.

### Three Speed Hub Assemblies

Gear Selector at Hub Axle

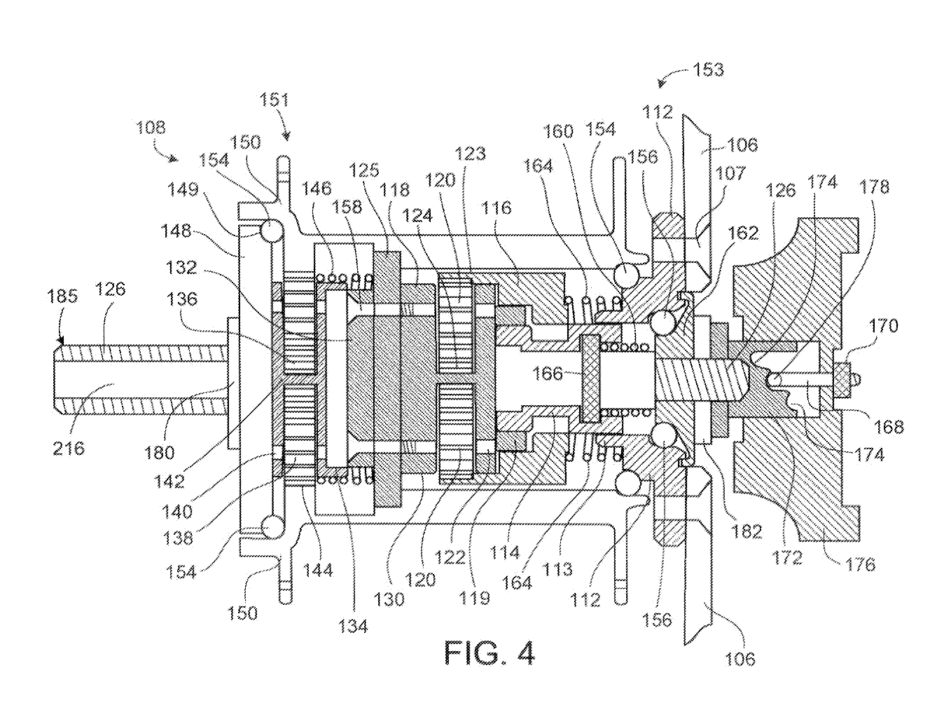

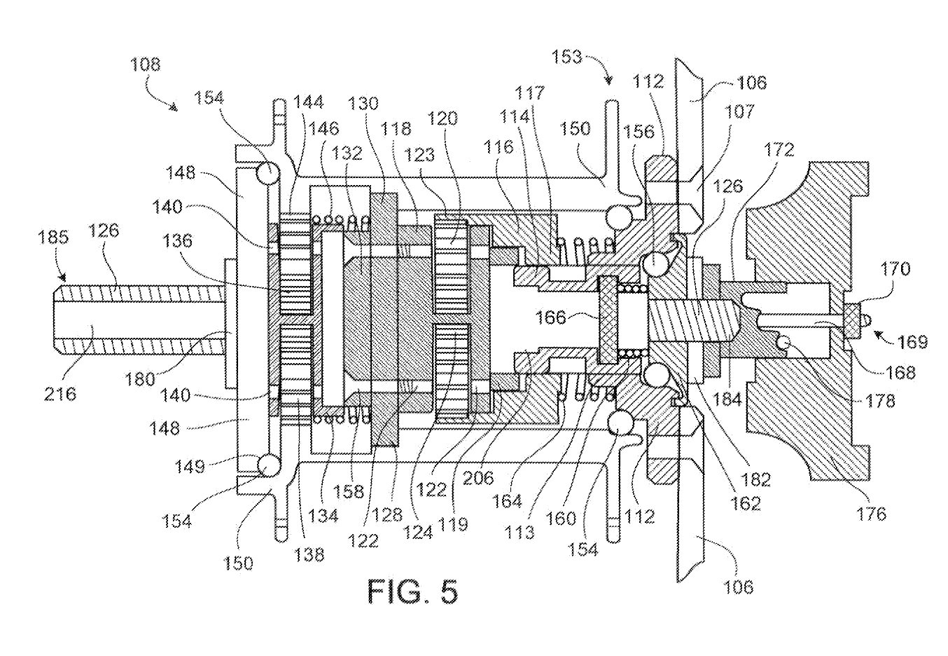

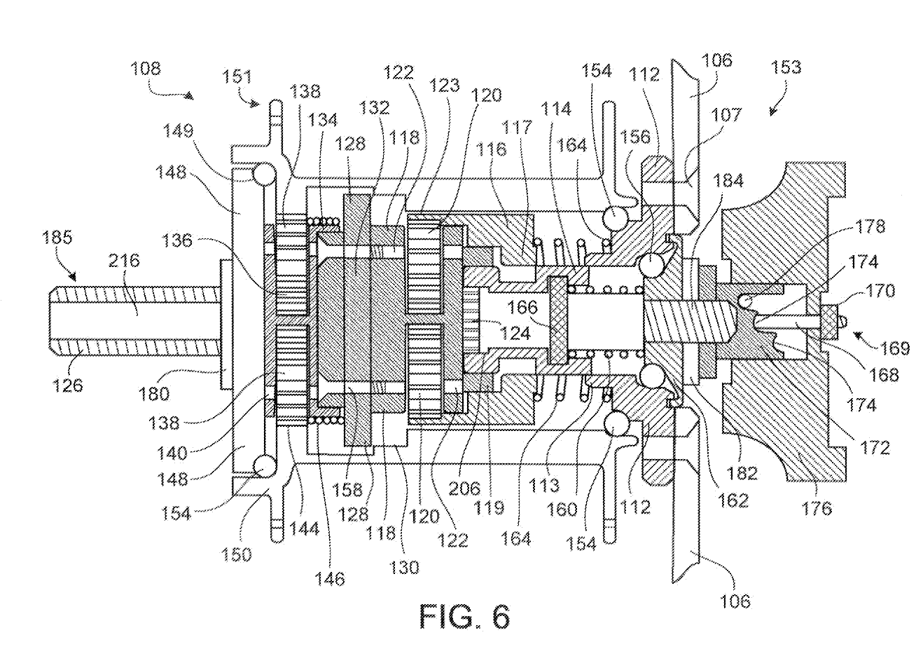

A three speed hub assembly 108 having a gear selector knob 176 positioned at one end of its axle (the unsupported end 184 of axle 126) is shown in FIGS. 3-6 and 12. The three speed hub assembly 108 shifts between gears by lateral motion of a hexagonal (“hex”) coupler 114 and a hexagonal (“hex”) drive plate 128 between the respective positions shown in FIGS. 4, 5 and 6. As a result of this lateral movement, in one position the hex coupler 114 directly drives the first planetary gear cage 118 (FIG. 4, 1:1 gear ratio), in a second position the hex coupler 114 indirectly drives the planetary gears 120 through a reduction ring gear 116 (FIG. 5, less than 1:1 gear ratio), and in a third position the hex coupler 114 drives the second planetary gear cage 142 by urging other components into engagement (FIG. 6, greater than 1:1 gear ratio). At all times, one or the other of the sets of gears is engaged, providing three transmission paths for fixed transmission of torque from the push rim drive plate 106 (exerted by the user on push rim 104), through the hub assembly 108, to the wheel assembly 110. Each transmission path is made up of cooperating rigid bodies (e.g., the hex coupler 114 and the planetary cage, in the path shown in FIG. 4), and each rigid body is configured to transmit torque in both forward and reverse directions, resulting in a “fixed gear” system.

When the gear selector 176 is moved between its settings, the hex coupler 114 is moved laterally by lateral movement of a hex coupler shift key 166, which is positioned within a circumferential internal key groove within the hex coupler 114. The hex coupler shift key 166, and thus the hex coupler 114 as well, is moved to the left by the force exerted by a hex coupler compression spring 160 (shown in its fully compressed state in FIG. 5) and to the right by tension exerted by a hex coupler shift rod 168 when the user turns the gear selector knob 176. The hex drive plate 128 moves left in response to pressure from the hex coupler 114 as it moves from the position shown in FIG. 4 to that shown in FIG. 6, and right in response to biasing pressure exerted by the drive plate compression spring 146. The components of the hub assembly 108 and their function will now be discussed in detail, followed by a discussion of how the transmission operates in use.

Referring to FIG. 3, the three speed hub assembly 108 includes a hub shell 150 which defines a hub shell ring gear 144 and a hub shell drive plate receiver 130. Driving force is transmitted from the push rim drive plate 106 to the wheel assembly 110 via the driving engagement of either the hub shell ring gear 144 or the hub shell drive plate receiver 130 with the internal components of the hub assembly 108.

The hub shell 150 houses the components of the drive train: hub driver 112; hex coupler 114; reduction ring gear 116, which defines an inner ring gear 123; a first planetary gear assembly including a first planetary gear cage 118, first planetary gears 120, first planetary gear axles 122, the hex drive plate 128, first planetary gear cage retaining screws 158, and a drive plate hex coupler 132; and a second planetary gear assembly including second planetary gear hexagonal receiver 134, second sun gear 136, second planetary gears 138, second planetary gear axles 140, and a second planetary gear cage 142.

A hub axle 126 extends through the hub shell 150 and carries the first sun gear 124 and the second sun gear 136, which engage with the first and second planetary gears, respectively. The second sun gear 136 is positioned between the drive plate hex coupler 132 and the backing plate 148. The second end 185 of the hub axle 126 includes opposing flat surfaces 216 and is affixed to the hub axle receiver (not shown). the hub axle receiver will vary according to the style and manufacturer of the wheelchair 100. In all cases, the hub axle receiver will prevent the rotation of the hub axle 126. Thus, the hub axle 126 remains stationary while the hub driver 112, planetary gears, and other components rotate about the axle 126.

The hub axle 126 is hollow on the first end 184, to receive a gear shifter rod 168, is threaded on both ends, and includes a longitudinal slot 186 between the middle of the axle 188 and the first end 184. The longitudinal slot 186 guides the lateral motion of the hex coupler shift key 166, discussed above, which is effected by the interaction between the spring force exerted by the hex coupler compression spring 160 and the pulling force exerted by the gear shifter rod 168, which is in turn controlled by rotation of the gear selector knob 176. The gear selector knob 176 is mounted on a gear selector knob receiver 172, and its rotation between the three gear settings is governed by a registration pin 178. The hub axle 126 also carries a backing plate 148.

the hub shell 150 is mounted on the hub axle 126, for rotation about the stationary hub axle 126. The hub shell 150 is held in position by hub shell ball bearings 154 on the hub driver side 153 of the hub shell 150, and by the hub shell ball bearings 154 on the backing plate side 151 of the hub shell 150. The hub shell ball bearings 154 are located between the hub shell 150 and the hub driver 112, and the hub shell ball bearings 154 are located between the hub shell 150 and the backing plate 148. The backing plate 148 is located between the backing plate ball bearings 154 and the dust cover (not shown). The dust cover is located about the axle 126 and between the backing plate 148 and the inner axle nut 180. The inner axle nut 180 is engaged about the threaded portion of the axle 126 at the second end 185 and in contact with the dust cover (not shown). The hub driver bearing inner race 162 is located between the hub driver bearing 156 and the outer axle nut 182. The outer axle nut 182 is engaged about the threaded portion of the axle 126 at the first end 184 and in contact with the hub driver inner race 162. The hub driver dust cover (not shown) is located about the hub driver 112 between the hub shell 150 and the push rim drive plate 106.

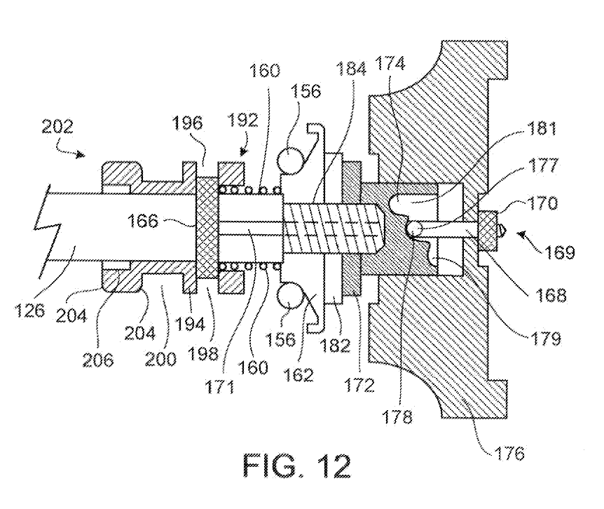

Referring to FIGS. 3, 8 and 12, the hex coupler 114 includes a longitudinal through-bore hole 207, a hexagonal male coupler at the first end 192 with an internal circumferential key groove 194, and two opposing holes 196 and 198 (FIG. 12), the hole 196 being larger than the shift key 166 diameter and the hole 198 being smaller than the shift key 166 diameter (as shown in FIG. 12). The shift key 166 is inserted through the larger hole 196 during assembly, and centered within the key groove 194. The smaller hole 198 allows the shift key 166 to be removed from the hex coupler 114 by unscrewing the shift key 166 from the shift rod 168 and pushing the shift key 166 out of the hex coupler 114, e.g., using a small pin. The shift key 166 is encapsulated in the internal key groove 194, to allow the hex coupler 114 to move laterally in response to movement of the shift key 166. The shift key 166 does not rotate; the circumferential key groove 194 allows the hex coupler 114 to rotate about the rotationally stationary shift key 166. The mid section 200 of the hex coupler 114 has a diameter smaller than the minor diameter of the first end 192 and second end 202 of the hex coupler 114, allowing the mid section 200 to slide past the ring gear hex receiver 117 without engaging it. The leading edges 204 of the second end 202 of the hex coupler 114 are beveled to facilitate insertion of the hex coupler 114 into either the first planetary gear cage hex receiver 119 or the ring gear hexagonal receiver 117. The second end 202 of the hex coupler 114 includes a recess large enough to allow the hex coupler 114 to rotate freely about the first sun gear 124 when the hex coupler 114 is in the position shown in FIG. 6.

the hub driver 112 contains a hexagonal receiver 113 which engages the first end 192 of the hex coupler 114. The first end 192 of the hex coupler 114 moves laterally within the hub driver hexagonal (“hex”) receiver 113, between the three positions shown in FIGS. 4-6, while maintaining constant positive engagement with the hex receiver 113.

The mid section 200 of the hex coupler 114 is positioned within the reduction ring gear receiver 117 when the hex coupler is in the positions shown in FIGS. 4 and 6, preventing the hex coupler 114 from driving the reduction ring gear 116 in these gear settings. The second end 202 of the hex coupler 114 is positioned to selectively engage either the hex receiver 119 within the first planetary gear cage 118 (as shown in FIGS. 4 and 6) or the hex receiver 117 within the reduction ring gear 116 (as shown in FIG. 5).

The reduction ring gear 116 rotates about the hub axle 126 and includes a hex receiver 117 at the first end 115 and an inner ring gear 123 at the second end 121. The inner ring gear 123 of the reduction ring gear 116 at the second end 121 is constantly engaged with the first planetary gears 120 of the first planetary gear cage 118, and drives the planetary gears 120 when the hex coupler 114 is engaged with the hex receiver 117.

The first planetary gear cage 118 rotates about the hub axle 126. Rotatably attached within the first planetary gear cage 118 are three or more first planetary gears 120, each of which rotates about its respective planetary gear axle 122. Each first planetary gear 120 is simultaneously engaged with the first sun gear 124 and the inner ring gear 123 of the reduction ring gear 116. The first sun gear 124 is affixed to the hub axle 126. The first planetary gear cage 118 is affixed to the hex drive plate 128 with two or more mechanical fasteners 158, such as screws or bolts, for example. Thus, rotation of the planetary gears 120 by the inner ring gear 123 when the hex coupler 114 is engaged with the ring gear hex coupler 117, will cause the first planetary gear cage 118 to rotate which will cause the hex drive plate 128 to rotate. Rotation of the first planetary gear cage 118 when the hex coupler 114 is engaged with the first planetary gear cage hex receiver 119 will also cause the hex drive plate 128 to rotate.

The hex drive plate 128 is positioned within the hub shell drive plate receiver 130 of hub shell 150, between the first planetary gear cage 118 and the second planetary gear cage hex receiver 134. As a result, rotation of the hex drive plate 138 will drive rotation of the hub shell 150 due to the engagement of the corresponding geometric (hexagonal) shapes of the hex drive plate 128 and the drive plate receiver 130.

The second planetary gears 138 are held in position by the second planetary gear cage 142 and rotate about the planetary gear axles 140. The second planetary gears 138 also engage the hub shell ring gear 144 which is integral to the hub shell 150 at the second end 151. Thus, driven rotation of the planetary gears 138 drives rotation of the hub shell 150. The backing plate 148 is positioned about the hub axle 126 between the second planetary gear cage 142 and the dust cover (not shown). The backing plate 148 includes the inner bearing race 149 for the hub shell bearings 154.

The drive plate compression spring 146 is located about the drive plate hex coupler 132 and the second planetary gear cage hex receiver 134 and is positioned between the hex drive plate 128 and the second planetary gear cage 142. The drive plate compression spring 146 is compressed when the hex coupler 114 is moved to the position shown in FIG. 6, and acts as a spring return, urging the hex drive plate 128 to the right, when the hex coupler 114 returns to the position shown in FIG. 4 or that shown in FIG. 5.

The gear selector knob 176 rotates about the gear selector knob receiver 172, which is affixed to the first end 184 of the hub axle 126. The gear selector knob 176 is rotatably attached to the gear shifter rod 168. The first end 169 if the gear shifter rod 168 is held in position by a threaded nut 170. The second end 171 of the gear shifter rod 168 is affixed to the hex coupler shift key 166. As discussed above, the hex coupler shift key 166 is positioned within the circumferential inner groove 194 of the first end 192 of the hex coupler 114 and within the longitudinal slot 186 of the hub axle 126.

The hex coupler compression spring 160 is positioned about the hub axle 126 and comes into contact at one end with the hub driver bearing inner race 162 and at the other end with the hex coupler shift key 166. As discussed above, the hex coupler compression spring 160 provides a biasing force urging the shift key 166 to the left in opposition to the pulling force exerted by the gear shifter rod 168.

The ring gear compression spring 164 is positioned about the hub axle 126 and comes into contact at one end with the hub driver 112 and comes into contact at the other end with the first end 115 of the reduction ring gear 116. The function of the ring gear compression spring 164 will be discussed below.

Referring to FIG. 1, in operation, the wheelchair user rotates the push rim 104 in a forward direction to propel the wheelchair 100 forward. With the wheelchair 100 in a stationary position, the user rotates the push rim 104 in a rearward direction to propel the wheelchair 100 rearward. With the wheelchair 100 moving in either a forward or rearward direction, the user grasps the push rim 104 to slow down and stop the wheelchair 100.

The user chooses the desired drive gear of the three speed hub assembly 108 using the gear selector knob 176 while the wheelchair 100 is stationary or in motion. The gear selector knob 176 is rotated in a clockwise or counterclockwise direction to select the desired gear ratio. The gear selector knob registration pin 178, positioned within the gear selector knob 176, engages the registration stops 174 (individual stops 177, 179, 181, collectively referred to as registration stops 174) located on the gear selector knob receiver 172 (see FIG. 12). When the pin 178 is seated in each of the three stops 177, 179, 181, of the gear selector knob 176, rotation of the push rim 104 rotates the push rim drive plate 106, which rotates the hub driver 112 which in turn rotates the hex coupler 114. Rotation of the hub driver is then transmitted through the gearing, as will be discussed below, to the hub shell 150, which rotates the driven wheel assembly 110.

With the gear selector knob 176 in a first position, in which the pin 178 is seated in the stop 177, the second end 202 of the hex coupler 114 is engaged with the first planetary gear cage hex receiver 119, as shown in FIG. 4. In this position, the hex coupler 114 rotates the first planetary gear cage 118, which rotates the hex drive plate 128. The hex drive plate 128 is engaged with and rotates the hub shell drive plate receiver 130, which rotates the hub shell 150. In this position, a one-to-one gear ratio is provided, which may be used, for example, for moving moderately on relatively flat ground.

With the gear selector knob 176 in a second position, in which the pin 178 is seated in the stop 179, the second end 202 of the hex coupler 114 is engaged instead with the reduction ring gear hex receiver 117 as shown in FIG. 5. In this case, the hex coupler 114 rotates the reduction ring gear 116, which rotates the first planetary gears 120. The first planetary gears 120 rotate about the first sun gear 124 affixed to the hub axle 126, thereby resulting in the rotation of the first planetary gear cage 118, which rotates the hex drive plate 128, which rotates the hub shell drive plate receiver 130, which rotates the hub shell 150. In this position, the ratio of the driven wheel rotation to the push rim rotation is less tan one-to-one, providing a mechanical advantage which is advantageous, for example, for going uphill.

It is noted that in both the first and second positions, force is transmitted from the push rim 104 to the wheel assembly 110, via the hub shell 150, by engagement of the hex drive plate 128 with the hub shell drive plate receiver 130.

With the gear selector knob 176 in the third position (FIG. 6), the second end 202 of the hex coupler 114 is engaged with the first planetary gear cage hex receiver 119 and the drive plate hex coupler 132 is engaged with the second planetary gear cage hex receiver 134. In this case the hex coupler 114 rotates the first planetary gear cage 118 which rotates the hex drive plate 128 which rotates the drive plate hex coupler 132, which rotates the second planetary gear cage hex receiver 134, which rotates the second planetary gear cage 142. The rotation of the second planetary gear cage 142 rotates the second planetary gears 138 about the stationary second sun gear 136, and also rotates the hub ring shell gear 144. In this position force is transmitted from the push rim 104 to the wheel assembly 110, via the hub shell 150, by engagement of the second planetary gears 138 with the hub shell ring gear 144, rather than by engagement of the hex drive plate 128 with the drive plate receiver 130. This position provides a gear ratio of greater than 1:1, which is advantageous, for example, when the user desires to move more quickly by having a greater degree of travel of the wheel assembly 110 per revolution of the push rim 104.

When the gear selector knob 176 is rotated into the first position from the second position, the hex coupler compression spring 160 exerts a lateral force against the shift key 166 which, as discussed above, is encapsulated within the internal groove 194 of hex coupler 114 and travels laterally within the longitudinal slot 186 of the hub axle 126. The hex coupler 114 is thereby driven laterally away from the hub driver 112, disengaging its second end 202 from the reduction ring gear hex receiver 117 and engaging the second end 202 with the first planetary gear cage hex receiver 119. This movement of the hex coupler 114 from the position shown in FIG. 5 to that shown in FIG. 4, results in the transmission shifting from a less than one-to-one gear ratio (reduction ring 117 engaged) to a one-to-one gear ratio (first planetary gears 120 engaged).

When the gear selector knob 176 is rotated back into the second position from the first position, the shifter rod 168 is pulled laterally within the longitudinal through bore 190 of the hub axle 126, which pulls the shift key 166 laterally toward the hub driver 112. This in turn draws the hex coupler 114 laterally along the hub axle 126 toward the hub driver 112, thereby disengaging the second end 202 of the hex coupler 114 from the first planetary gear cage hex receiver 119 and engaging it with the reduction ring gear hex receiver 117. The ring gear compression spring 164 applies a lateral force to the first end of the reduction ring gear 115, thereby assuring that the reduction ring gear 116 maintains full engagement with the first planetary gear cage 118.

When the gear selector knob 176 is rotated into a third position from the first position, the hex coupler compression spring 160 again exerts a lateral force against the shift key 166, which is counteracted to a lesser extent by the pulling force of the shifter rod 168 which is decreased in the third position. The hex coupler 114 is thereby driven laterally further away from the hub driver 112 (to the left in FIGS. 4 and 6), disengaging the first planetary gears 120 from the first sun gear 124. This action drives the hex drive plate 128 out of engagement with the hub shell drive plate receiver 130, and engages the hex drive plate hex coupler 132 with the second planetary gear hex receiver 134. It should be noted that the recess 206 within the second end 202 of the hex coupler 114 allows the hex coupler 114 to travel laterally over the first sun gear 124 without engaging the first sun gear 124.

When the gear selector knob 176 is rotated into the first position from the third position, the shifter rod 168 is pulled laterally within the longitudinal through bore of the hub axle 190, which pulls the shift key 166 laterally toward the hub driver 112, which draws the hex coupler 114 laterally along the hub axle 126 toward the hub driver 112. This lateral movement allows the drive plate compression spring 146 to expand, which causes the hex drive plate 128 to re-engage with the hub shell drive plate receiver 130. At the same time, the drive plate hex coupler 132 is disengaged from the second planetary gear cage hex receiver 134 and the first planetary gears 120 are re-engaged with the first planetary sun gear 124.

To facilitate smooth engagement of the hexagonal coupler 114 with the corresponding hexagonal receivers 117,119,134 during the gear shifting operation, the leading edges 204 of the second end 202 of the hexagonal coupler 114 and the leading edges (not shown) of the hexagonal receivers 117,119,134 are beveled. To further facilitate smooth engagement, the leading edges 204 of the hex coupler 114 form a concentric circle with a diameter equal to the minor diameter of the hexagonal form. The leading edges of the hexagonal receivers 117,119,134 form a concentric circle with a diameter equal to the major diameter of the hexagonal form.

It is noted that with proper tolerances, the engagement and disengagement of the male couplers 114, 132 and female receivers 117,119,134,253 is accomplished while introducing no significant backlash that would impede the operation of a propulsion system 102,103 as described. For example, in some preferred implementations the backlash is less than 5 degrees, preferably less than 1 degree.

Gear Selector on Wheelchair Frame

Referring now to FIGS. 2, 7 and 11 in other embodiments the three speed hub assembly 109 and the two speed hub assembly 249 each include a bell crank gear shifter assembly 220 located at the supported end of the hub axle 185, and a gear selector 222 located on the wheelchair frame 218 in a position convenient to the user. In this embodiment, the supported end of the hub axle 185 has a longitudinal hollow bore (not shown).

The bell crank gear shifter assembly 220 includes a gear shift push rod 224, shift key 166, bell crank mount 226, bell crank 228, cable 232, cable housing 238 and cable housing stop 240. The gear shift push rod 224 is positioned within the hollow longitudinal bore (not shown) of the supported end 185 of the hub axle 126. The first end 225 of the gear shift push rod 234 is connected to the shift key 166. The second end 227 of the gear shift push rod 224 is in contact with the bell crank 228. The bell crank mount 226 is threadably affixed to the supported end 185 of the hub axle 126. The bell crank mount 228 is rotatably attached to the bell crank mount 226. The first end 234 of the cable 232 is attached to the bell crank arm 230. The second end (not shown) of the cable 232 is attached to the gear selector 222. The cable 232 is positioned within a cable housing 238, which is secured to the bell crank mount 226 at one end and the gear selector 222 at the other end.

In operation, the user positions the gear selector 222 according to the gear that is desired. The movement of the gear selector 222 results in a corresponding movement of the cable 232 within the housing 238. The movement of the cable 232 results in a corresponding rotation of the bell crank arm 230, which results in a corresponding lateral movement of the gear shift push rod 224 within the supported end 185 of the hub axle 126, which results in a corresponding movement of the shift key 166. In this embodiment, the operation of the shift key 166, hex coupler 114 and hex coupler compression spring 160 is identical to the operation described in earlier embodiments.

### Two Speed Hub Assemblies

Gear Selector at Unsupported End of Hub Axle

The two speed hub assembly 248 shown in FIGS. 8, 9 and 10 is very similar, in both its components and its manner of operation, to the three speed hub assembly 108 shown in FIGS. 3-6 and described above. Thus, in the following discussion we will only describe the differences in the two speed configuration.

The two speed hub assembly 248 differs in that the second set of planetary gears 138 and second sun gear 136 have been eliminated, as well as the integral ring gear 144 on the three speed hub shell 150. Instead, the two speed hub assembly 248 includes only a single planetary gear assembly including a planetary gear cage 252, planetary gears 254, planetary gear axles 256, sun gear 258 and planetary gear cage retaining screws 266. The planetary gear cage 252 is affixed to a hub shell drive plate 260 with two or more mechanical fasteners 266, such as screws or bolts, for example.

The hub shell drive plate 260 is integral to the hub shell 262 and is positioned between the planetary gear cage 252 and the backing plate 264. As noted above, the hub shell 262 does not include an internal ring gear.

As discussed above with regard to the embodiment shown in FIGS. 3-6, the user chooses the desired drive gear of the two speed hub assembly 248 by rotating the gear selector knob 176 in a clockwise or counterclockwise direction to select the desired gear ratio. Rotation of the gear selector knob 176 causes the same lateral movement of the hex coupler 114 and other components discussed above with regard to FIGS. 4-6, except that there are only two positions between which the components are moved and the second sun gear 136, second planetary gears 138, second planetary gear cage 142, hub shell ring gear 144 and drive plate compression spring 146 have been removed.

Thus, when the gear selector knob 176 is rotated into a first position, the hex coupler compression spring 160 exerts a lateral force against the hex coupler shift key 166 which is encapsulated within the circumferential internal groove 194 of the hex coupler 114. The hex coupler 114 is driven laterally away from the hub driver 112, disengaging from the ring gear hexagonal receiver 117 and engaging the second end 202 of the hex coupler 114 with the planetary gear cage hexagonal receiver 253.

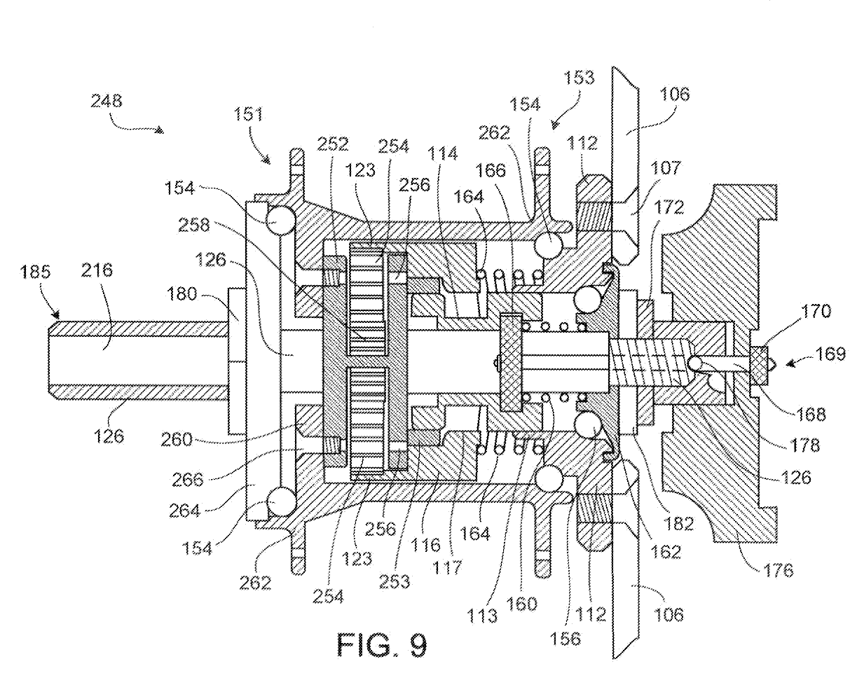

With the gear selector knob 176 in this first position, rotation of the hexagonal coupler 114 by the hub driver 112 rotates the planetary gear cage 252, which rotates the hub shell drive plate 260, which in turn rotates the hub shell 262 and thus the driven wheel assembly 110 of the wheelchair 100. This position, shown in FIG. 9, provides a one-to-one gear ratio.

When the gear selector knob 176 is rotated into a second position, the shift rod 168 is pulled laterally within the longitudinal hollow bore 190 of the axle 126, which pulls the shift key 166, and thus the hex coupler 114, laterally toward the hub driver 112. This movement disengages the hex coupler 114 from the planetary gear cage hexagonal receiver 253 and engages the ring gear hex receiver 117. The ring gear compression spring 164 applies a lateral force to the first end 115 of the ring gear 116, thereby assuring that the ring gear 116 maintains full engagement with the planetary gear cage 252.

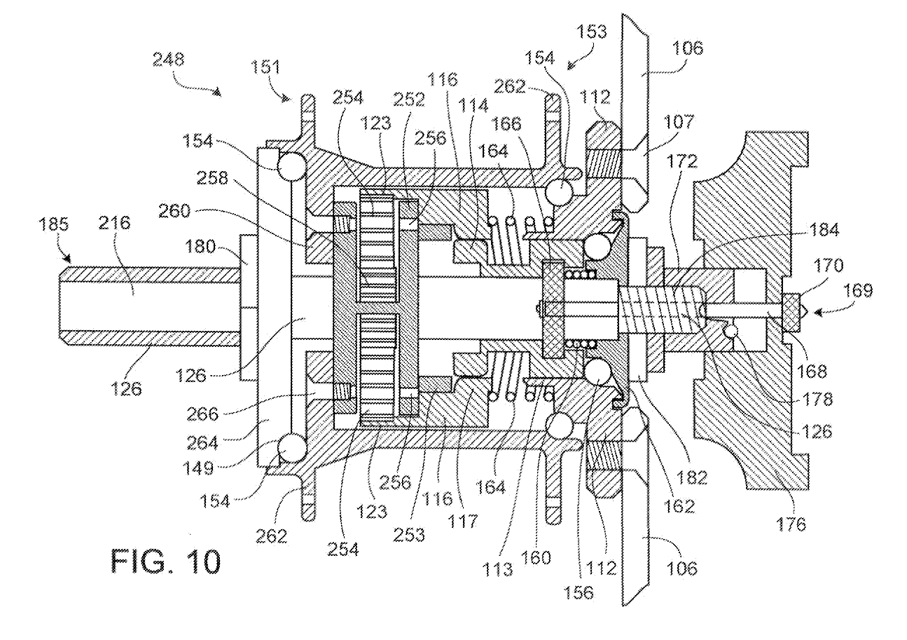

With the gear selector knob 176 in this second position, rotation of the hex coupler 114 by the hub driver 112 rotates the ring gear 116, which rotates the planetary gears 254 which rotate about the sun gear 258 affixed to the hub axle 126, thereby resulting in the rotation of the planetary gear cage 252. Rotation of the planetary gear cage 252 in turn rotates the hub shell drive plate 260, which in turn rotates the hub shell 262 and thus the driven wheel assembly 110. This position (FIG. 10) provides a less than one-to-one gear ratio.

To facilitate smooth engagement of the hex coupler 114 with the corresponding hexagonal receivers 117,253 during the gear shifting operation, the leading edges 204 of the second end 202 of the hexagonal coupler 114 and the leading edges (not shown) of the hexagonal receivers 117,253 are beveled. To further facilitate smooth engagement, the leading edges 204 of the hex coupler 114 form a concentric circle with a diameter equal to the minor diameter of the hexagonal form. The leading edges of the hexagonal receivers 117, 253 form a concentric circle with a diameter equal to the major diameter of the hexagonal form.

### Other Embodiments

A number of embodiments of the invention have been described. Nevertheless, it will be understood that various modifications may be made without departing from the spirit and scope of the invention.

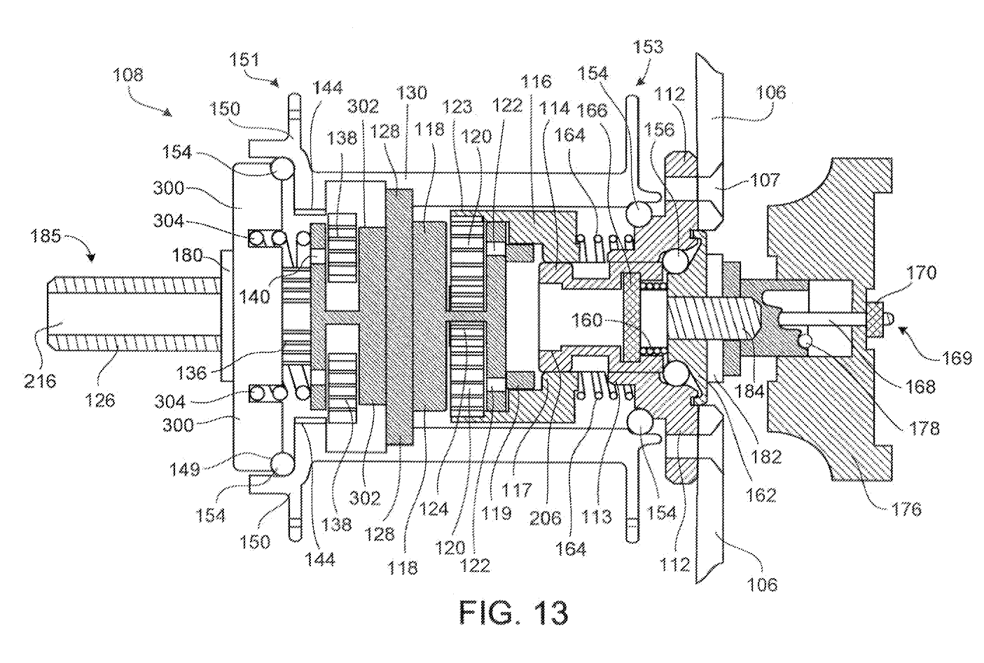

For example, referring to FIG. 13, in one implementation the drive plate hex coupler 132 and the second planetary gear cage hex receiver 134 shown in FIG. 5 are eliminated and the second planetary gear cage 142 is affixed to the hex drive plate 128 within the 3 speed hub shell 150. The drive plate compression spring 146 shown in FIG. 5 is replaced with a modified drive plate compression spring 304 that is positioned between the modified backing plate 300 and the modified second planetary gear cage 302. The modified backing plate 300 receives one end of the modified drive plate compression spring 304. In operation, when the gear shift knob 176 is rotated from the third position (greater than one-to-one gear ratio) to the second position (less than one-to-one), the hex coupler 114 moves laterally toward the hub driver 112 thereby allowing the modified drive plate compression spring 304 to expand which moves the modified second planetary gear cage 302, the hex drive plate 128 and the first planetary gear cage 118 laterally toward the hub driver 112. This lateral movement disengages the second planetary gears 138 from the second sun gear 136 and the hub shell ring gear 144. This lateral movement engages the second end 202 of the hex coupler 114 with the ring gear hex receiver 117 and also engages the hex drive plate 128 with the hub shell drive plate receiver 130. It may be noted that the operation of the gear selector knob 176, shift rod 168, hex coupler 114, hex coupler shift key 166, reduction ring gear 116 and first planetary gear cage 118 remain unchanged from earlier embodiments.

In some implementations, the geometric form of the hexagonal coupler 114 and the hexagonal drive plate 128, and the geometric form of the hexagonal receivers 117, 119, and 134, and the hexagonal hub shell drive plate receiver 130, may be replaced with any polygonal shape, e.g., square, triangular or octagonal, or may be replaced with a straight-sided spline.

Moroever, it is noted that shifting may be accomplished by either a pushing action of the gear shift rod 224 (e.g., as described with regard to FIG. 7), or a pulling action of the gear shift rod 168 (e.g., as described with regard to FIGS. 3-6).

Additionally, the gear selector may be positioned at the unsupported end 184 of the hub axle 126 in some embodiments, and at the supported end 185 of the hub axle 126 in other embodiments, e.g., as shown in FIG. 11 and discussed above.

Also, the two speed hub assembly 249 may be configured to include a gear selector 222 on the wheelchair frame 218, as discussed for the three speed hub assembly 109 with reference to FIGS. 7 and 11.

It is further understood that the positioning of the compression springs 146, 160, 164 may be different amongst various embodiments. However, the fundamental principles underlying the components and their actions are unchanged.

Accordingly, other embodiments are within the scope of the following claims.

What is claimed is:

1. A push rim wheelchair comprising
a wheel assembly including a drive wheel,
a push rim positioned for manual operation by a user of the wheelchair, and
a multi-speed hub transmission configured to transmit torque from the push rim to the drive wheel, the multi-speed hub transmission comprising
a hub connected to the drive wheel of the wheelchair,
a hub driver connected to the push rim of the wheelchair,
a drive train, configured to transmit torque from the hub driver to the hub at each of at least three gear ratios, the drive train comprising cooperating gears a and defining at least three different torque transmission paths between the hub driver and the hub, each path defining a respective one of the gear ratios, and
a gear selector manipulable to select between the multiple gear ratios by selectively engaging respective torque transmission paths of the drive train,
wherein each of he transmission paths includes only rigid bodies, each of the rigid bodies being configured to transmit torque in both forward and reverse rotational directions.

2. The wheelchair of claim 1 wherein the torque of the drive train is transmitted to the hub through a drive plate at gear ratios equal to or less than one-to-one, and the through a ring gear integral to the hub in the case of a gear ratio greater than one-to-one.

3. The wheelchair of claim 1 wherein at lest two of the sets of gears include, as one of the cooperating gears, a planetary gear assembly.

4. The wheelchair of claim 1 wherein each set of gears includes a first gear member having a geometric recess configured to be engaged by a corresponding cooperating geometric member to selectively engage the set of gears.

5. The wheelchair of claim 4 wherein one of the corresponding geometric members is a coupler, and the coupler is configured to move axially within the hub.

6. The wheelchair of claim 5 wherein another of the corresponding geometric members is mounted on a second gear member of one of the sets of gears, and is configured to engage the geometric recess in the first gear of an adjacent set of gears.

7. The wheelchair of claim 5 wherein each of the three transmission paths involves a planetary gear assembly.

8. The wheelchair of claim 7 wherein in one of the transmission paths the planetary gear assembly is driven directly by the coupler, and in another of the transmission paths the planetary gear assembly is driven by a reduction gear, which is in turn driven by the coupler.

9. The wheelchair of claim 1 wherein the hub defines a portion of one of the sets of gears.

10. The wheelchair of claim 9 wherein the hub further defines a recess configured to be engaged by a correspondingly shaped outer portion of another of the sets of gears.

11. The wheelchair of claim 5 further comprising a member constructed to apply a lateral force to the coupler in a first direction, and a resilient element constructed to apply a lateral force to the coupler in a second, opposite direction.

12. The wheelchair of claim 11 wherein the gear selector is configured to adjust the lateral force in the first direction when it is moved between predetermined positions.

13. The wheelchair of claim 1 wherein the gear selector is positioned at an end of the hub assembly.

14. The wheelchair of claim 1 wherein the gear selector is positioned on a frame of the wheelchair.

15. The wheelchair of claim 1 wherein the drive train is configured to provide a fixed gear transmission of torque.

16. The wheelchair of claim 1 wherein the drive train is configured to provide less than 5 degrees of backlash when force is first applied by the user to the push rim.

17. A push rim wheelchair comprising
a wheel assembly including a drive wheel,
a push rim positioned for manual operation by a user of the wheelchair, and
a multi-speed hub transmission configured to transmit torque from the push rim to the drive wheel,
the multi-speed hub transmission comprising:
a hub, connected to the drive wheel,
a hub driver, connected to the push rim, and
a drive train, positioned within the hub and configured to transmit torque between the hub driver and the hub at each of at least three gear ratios,
wherein the drive train exhibits a backlash of less than 5 degrees when a force is first transmitted to the push rim by an operator of the wheelchair.

18. A push rim wheelchair comprising
a wheel assembly including a drive wheel,
a push rim positioned for manual operation by a user of the wheelchair, and
a multi-speed hub transmission configured to transmit torque from the push rim to the drive wheel and comprising:
a hub, connected to the drive wheel,
a hub driver, connected to the push rim,
a gear selector, positioned to allow an operator of the wheelchair to select between speeds of the transmission, and
a drive train, comprising cooperating gears configured to transmit torque between the hub driver and the hub at each of at least two gear ratios including a first gear ratio greater than one-to-one, and a second gear ratio less than or equal to one-to-one,
wherein the torque of the drive train is transmitted to the hub through a drive plate for the second gear ratio, and through a ring gear integral to the hub for the first gear ratio.

19. The wheelchair of claim 18 wherein the cooperating gears comprise at least one planetary gear assembly.

20. The wheelchair of claim 18 wherein the drive train further comprises a coupler configured to move axially within a hub assembly between a first position in which the torque is transmitted through the drive plate, and a second position in which torque is transmitted through the ring gear.
